(19) United States
(12) Patent Application Publication
(10) Pub. No.: US 2012/0166260 A1
(43) Pub. Date: Jun. 28, 2012

(54) SYSTEM AND METHOD FOR PROVIDING CELEBRITY ENDORSED DISCOUNTS

(76) Inventors: Chad Steelberg, Newport Beach, CA (US); Ryan Steelberg, Irvine, CA (US)

(21) Appl. No.: 13/306,405

(22) Filed: Nov. 29, 2011

Related U.S. Application Data
(63) Continuation-in-part of application No. 12/833,143, filed on Jul. 9, 2010.
Application No. 12/833,143 is a continuation-in-part of application No. 12/466,091, filed on May 14, 2009.
Application No. 12/466,091 is a continuation-in-part of application No. 12/221,058, filed on Jul. 30, 2008.
Application No. 12/221,058 is a continuation-in-part of application No. 12/220,916, filed on Jul. 29, 2008.
Application No. 12/220,916 is a continuation of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007, now Pat. No. 7,809,603.
Application No. 11/981,837 is a continuation-in-part of application No. 12/072,692, filed on Feb. 27, 2008.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008.
Application No. 12/042,913 is a continuation-in-part of application No. 12/072,692, filed on Feb. 27, 2008.
Application No. 12/072,692 is a continuation-in-part of application No. 11/981,646, filed on Oct. 31, 2007.
(60) Provisional application No. 61/417,555, filed on Nov. 29, 2010.
(60) Provisional application No. 61/065,297, filed on Feb. 7, 2008.
(60) Provisional application No. 61/131,386, filed on Jun. 6, 2008.
(60) Provisional application No. 60/993,096, filed on Sep. 7, 2007.

(51) Int. Cl. G06Q 30/02

(52) U.S. Cl. 705/14.13

(57) ABSTRACT

An advertising engine, system and method for formulation of endorsed advertising. The engine, system and method includes at least one computerized storage vault including a plurality of media assets correspondent to each prospective endorser for the endorsed advertising, and a graphical user interface for presentation of the plurality of media assets having a multi-layer format. The graphical user interface may include a library that presents at least a first layer including available ones of the prospective endorsers, and at least a second layer including ones of the media assets correspondent to each of the prospective endorsers, and a recommendation engine that presents at least ones of the media assets correspondent to a plurality of ranked ones of the prospective endorsers from the vault responsive to a request for the endorsed advertising.

### CROSS-REFERENCE TO RELATED APPLICATION

This application claims priority to U.S. Provisional Patent Application Ser. No. 61/417,555, filed Nov. 29, 2010, entitled System and Method for Providing Celebrity Endorsed Discounts, and is a continuation-in-part of U.S. patent application Ser. No. 12/833,143, entitled “System and Method for Secured Delivery of Creatives,” filed Jul. 9, 2010, which is a continuation-in-part of U.S. patent application Ser. No. 12/466,091, entitled “System And Method For On-Demand Delivery Of Audio Content for Use With Entertainment Creatives,” filed May 14, 2009, which is a continuation-in-part of U.S. patent application Ser. No. 12/221,058, entitled “System And Method For Distributing Content For Use With Entertainment Creatives Including Consumer Messaging,” filed Jul. 30, 2008, which is a continuation-in-part of U.S. patent application Ser. No. 12/220,916, entitled “System and Method For Preemptive Brand Affinity Content Distribution”, filed Jul. 29, 2008.

U.S. patent application Ser. No. 12/220,916 is: a continuation-in-part of U.S. patent application Ser. No. 12/144,194, entitled “System and Method for Brand Affinity Content Distribution and Optimization”, filed Jun. 23, 2008; claims priority to U.S. Provisional Patent Application Ser. No. 61/065,297, entitled “System and Method of Assessing Qualitative and Quantitative Use of a Brand,” filed Feb. 7, 2008; and claims priority to U.S. Provisional Patent Application Ser. No. 61/131,386, entitled “Apparatus, System and Method for a Brand Affinity Engine Using Positive and Negative Mentions”, filed Jun. 6, 2008.

U.S. patent application Ser. No. 12/144,194 is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007, now U.S. Pat. No. 7,809,603 issued on Oct. 5, 2010; a continuation-in-part of U.S. patent application Ser. No. 12/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008.

U.S. patent application Ser. No. 11/981,837 claims priority to U.S. Provisional Application Ser. No. 60/993,096, entitled “System and Method for Rule-Based Generation of Brand Affinity Content,” filed Sep. 7, 2007, and is related to U.S. patent application Ser. No. 11/981,646.

U.S. patent application Ser. No. 12/079,769 is a continuation-in-part of U.S. patent application Ser. No. 12/042,913, entitled “Engine, System and Method for Generation of Brand Affinity Content,” filed Mar. 5, 2008, which is also a continuation-in-part of U.S. patent application Ser. No. 12/072,692.

U.S. patent application Ser. No. 12/072,692 is a continuation-in-part of U.S. patent application Ser. No. 11/981,646.

### FIELD OF THE INVENTION

The present invention is directed to a system and method for branding and advertising, and more particularly, to an engine for accessing and generating brand affinity content, and methods of making and using the same.

### BACKGROUND OF THE INVENTION

High impact advertising is that advertising that best grabs the attention of a targeted consumer. A target consumer is typically identified as the ideal customer for the particular good or service being advertised. This identification can arise from factors such as socio-economics, moral or value bases, age, gender, geography, interest levels or other perspective. The impact on an ideal customer of any particular advertisement may be improved if an advertisement includes endorsements, sponsorships, or affiliations from those persons, entities, or the like from whom the ideal target consumer has an increased likeliness to identify with, seek guidance from, or gain an increased sense of empowerment. Factors that will increase the impact of an endorser include the endorser's perceived knowledge of particular goods, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for brand development and the obtaining of an endorsement or sponsorship from specific individuals, entities, brands, marketing partners, or sponsors.

### SUMMARY OF THE INVENTION

An advertising engine, system and method of using is described. The engine includes at least one vault including a plurality of media assets, a recommendation engine that matches at least one media asset from the vault with at least one requested creative, a delivery engine that integrates the requested creative with the matched media assets from the vault, and a management engine that regulates and/or tracks ones of the at least one media asset. The method includes the steps of requesting at least one creative based on at least one information item, matching at least one stored media asset to the at least one creative, integrating the at least one stored media asset to the at least one creative, and regulating the at least one media asset matched to the at least one creative.

### BRIEF DESCRIPTION OF THE FIGURES

Understanding of the present invention will be facilitated by consideration of the following detailed description of the embodiments of the present invention taken in conjunction with the accompanying drawings, in which like numerals refer to like parts and in which:

FIG. 1 illustrates an exemplary embodiment of the present invention; and

FIG. 2 illustrates another exemplary embodiment of the present invention.

FIG. 3 is an exemplary embodiment of a registration and login display of the present invention;

FIG. 4 is an exemplary embodiment of a brand selection and development display of the present invention;

FIG. 5 is an exemplary embodiment of a brand selection and development display of the present invention;

FIG. 6 is an exemplary embodiment of a brand selection and development display of the present invention;

FIG. 7 is an exemplary embodiment of a brand selection and development display of the present invention; and
FIG. 8 is an exemplary embodiment of a brand selection and development display of the present invention;

FIG. 9 is an exemplary embodiment of a brand selection and development display of the present invention;

FIG. 10 is an exemplary embodiment of a brand selection and development display of the present invention;

FIG. 11 is an exemplary embodiment of a brand selection and development display of the present invention;

FIG. 12 is an exemplary embodiment of a brand selection and development display of the present invention;

FIG. 13 is an exemplary embodiment of a campaign selection and development display of the present invention; and

FIG. 14 is an exemplary embodiment of a campaign selection and development display of the present invention;

FIG. 15 is an exemplary embodiment of a campaign selection and development display of the present invention;

FIG. 16 is an exemplary embodiment of a campaign selection and development display of the present invention;

FIG. 17 is an exemplary embodiment of a campaign selection and development display of the present invention; and

FIG. 18 is an exemplary embodiment of a campaign selection and development display of the present invention;

FIG. 19 is an exemplary embodiment of a campaign selection and development display of the present invention;

FIG. 20 is an exemplary embodiment of a campaign selection and development display of the present invention;

FIG. 21 is an exemplary embodiment of a manager and administrative control display of the present invention;

FIG. 22 is an exemplary embodiment of a sponsor and associated asset tree menu;

FIG. 23 is a flow chart of a method of generating and determining a buzz value; and

FIG. 24 is an exemplary embodiment of a system of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical advertising engines, systems and methods. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which have been approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

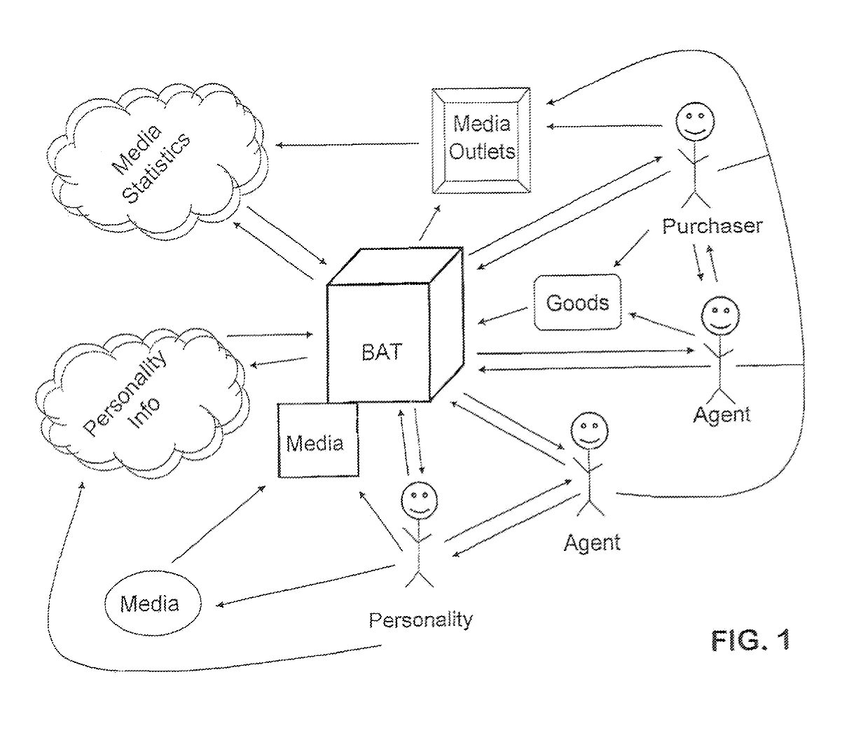

At present, there is a need for a platform or engine to allow for the obtaining of an endorsement, or endorsed ad, in any of the aforementioned circumstances, either from a specific individual, a specific entity, an affinity brand, a marketing partner, or a sponsor. As may be seen in FIG. 1, the development of a targeted advertisement involves a dynamic interrelationship between all relevant factors, such as, for example, the goods, the purchasers, the endorsing personalities and their agents, and the existing or upcoming media associated with each. The ideal advertisement engine must be able to harness and manage all aspects of each of these factors, based upon only a limited number of parameters from which to initiate and generate the advertisement.

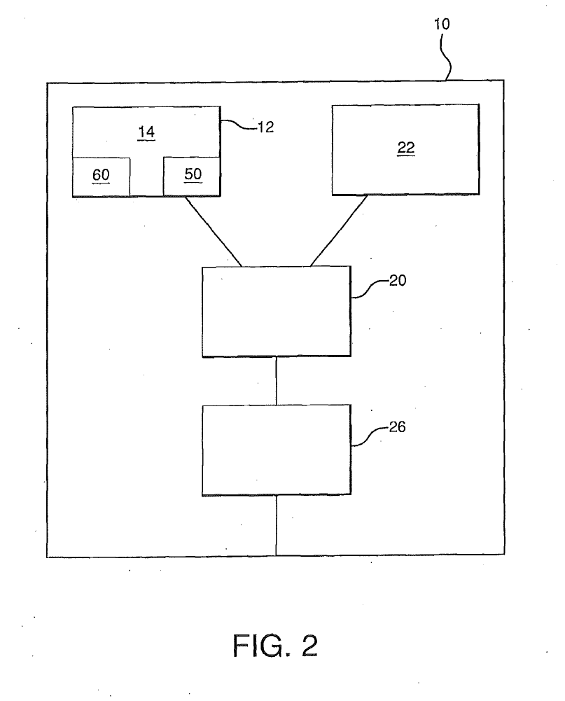

According to an aspect of the present invention, an endorsed advertising engine 10, such as that illustrated in FIG. 2, may include a vault 12 that provides media assets 14 and integration of media assets without need of involving the media assets for permission, a brand association or recommendation engine 20 that may, by creative, by market, by brand affinity, by user request, or otherwise match media assets from the vault with a requested creative/ad 22, and a delivery engine 26 capable of integrating a requested ad 22 with the media assets 14 from the vault 12, late stage binding of the requested ad 22 and media assets 14 upon delivery to strongest target consumers, and delivery of the requested ad 22 and the media assets 16 from the vault to an advertiser or advertising server, which then places the mash up of the ad and media asset. Requested ad 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works, including all metadata associated with any media form. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video.

Media assets may further include such items that are predictive of certain future events for purposes of integrating and scheduling certain media assets for maximum value. For example, media assets pertaining to a particular Major League Baseball starting pitcher can identify those locations, days and game start times for that pitcher. Based on this identified schedule, the ad can be requested in advance, and subsequently constructed, delivered and aired on a recurring basis. In another example, media assets may identify a particular golfer who is leading a PGA event prior to the final round. Likewise, the present invention may provide percentage chances of future events to occur based on collected media assets or other collected data, and provide ad requestors the opportunity to identify and utilize endorsers who may have significantly increased value within a relative future timeframe.

The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

According to an aspect of the present invention, media assets associated with particular people, entities or estates may be contractually obligated for endorsement of individual media assets or sets of media assets prior to storage of such assets in the vault. Such contractual obligation may provide for a more streamlined process of media asset recommendation. In another example, such contractual obligation or pre-existing obligation may become part of the media asset descriptor or tag, such that an ad requestor may select or search for only those media assets that do not require further contracting for use in the requested ad. In such an embodiment, the present invention may include a separate management engine or functionality (see further description below) to monitor, review or confirm the presence or absence of contractual matters associated with internal and/or external media assets.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally it may use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from activity data, such as on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling results and/or metadata may provide for local or national focus and maintained in the vault as an associated media asset with a particular brand, and best matches for certain brands may be selected according to such polling results or associated metadata. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

According to another aspect of the present invention, the media assets may be categorized and ranked or tagged for identification by the recommendation engine. For example, the input for the requested ad 22 may be compared with media assets 14, and a weighting or similarity calculation is computed between the requested ad 22 and the media assets 14. Such calculations and comparisons may be made with individual media assets, or with any sort of media asset sets or subsets. Prior to delivery to the ad requestor, the media assets 14 with the highest weight values or other similarity comparator relative to the requested ad 22 may be merged into a single deliverable, such as in a list form, where each media asset 14 or media asset set may identify the weight value associated with it. In this exemplary embodiment, weight values may reflect the degree of similarity to the requested ad 22.

The searching function of the recommendation engine for identifying media assets for weighting and ranking may include those tagging and searching tools as understood by those having skill in the art. For example, the media assets may include all forms of metadata, tags, unique descriptors (pointers or identifiers), or even digital representations of the media assets themselves.

In another aspect of the present invention, requested ads 22 may themselves become media assets, and as a further example, such requested ads that become media assets may provide the recommendation engine additional knowledge for future recommendations. This may in effect allow the recommendation engine to “learn” the ad request patterns for providing repeat requestors or similar ad requestor more desirable recommended media assets. In other words, the human aspects of the profiles themselves become media assets and thus provide a feedback loop for increasing the amount of desirous recommended media assets beyond that which can be identified via tags or descriptors.

Similarity calculations may be further constructed to match at different levels of abstraction. In such embodiments, mapping functions may be used to associate particular items in the requested ad 22 to a more general description of a media asset 14 or media asset set. The level of abstraction may be a function of the search parameters, or may be a functionality of the price paid or the complexity of the media asset search requested.

Thus, the recommendation engine may passively or actively inform or otherwise identify the best endorsement matches for a particular user's ads, based on any number of factors, and limited only by the amount and type of information identified in the requested ad. Upon assessment of good matches for the requesting ad or even brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

According to yet another aspect of the present invention, the engine 10 may be used for identifying and recommending a brand itself instead of an ad. For example, the recommendation engine may match media assets from the vault with product identifiers and descriptors entered by a requestor, such that the recommendation engine may identify and match those media assets for branding the product. Results from the recommended branding may then be reentered to the advertising engine 10 via a requested ad 22 as described above to produce an endorsed ad for deliver to an advertiser or advertising server.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as in the event that later stage tracking can further improve ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

According to another aspect of the present invention, a management engine may be used for performing various managerial functions, such as tracking, reporting, quality control, legal or other regulating mechanisms associated with advertisement engine 10. The management engine may be used within advertisement engine 10 at any point in the recommendation and delivery process, as well as in follow up on delivered or aired ads. The management engine may also act as a regulating body for inclusion or exclusion of media assets prior to storage in the vault.

For example, in one exemplary embodiment, the management engine may be used for tracking media assets during the recommendation and delivery process. The media assets may be tracked by the number of hits they receive for recommendation and or the number of times the media assets are authorized for delivery to the advertiser. The ads themselves may also be tracked by the management engine based on any sort of parameters, using tracking mechanisms as understood by those having skill in the art.

In another exemplary embodiment, reports may be generated, reviewed and delivered to advertisers, endorsers, agents or other third parties, where such reports relate to the various components of the advertisement engine, such as the ads, ad requests, and/or the media assets. Reports may also be based on any tracking records.

The management engine may be used to contact and gain agent approval for particular endorsers, either prior to storage of the associated media assets in the vault, or upon selection of those associated media assets by the recommendation engine in response to the requested ad. The management engine may also verify any parameters associated with contractual obligations attached to the media assets, and may alert the ad requestor, the advertiser, or other party as to the results of such verification.

The management engine may also be used to screen existing media assets in the vault and filter or even remove media assets from the vault. For example, if a media asset is determined to have a tag or descriptor that is no longer relevant, or is otherwise incorrect, the management engine may remove the tag or descriptor, or even remove the media asset from the vault entirely.

According to an aspect of the present invention, the present invention may incorporate application architecture that may include a software framework and graphical user interface that optimizes ease of use of the software platform, and that may also extend the capabilities of the software platform. The application architecture may approximate the actual way users organize and conduct activities, and thus may organize activities in a natural, coherent manner while delivering activities through a simple, consistent, and intuitive interface within each application and across applications. The architecture may also be reusable, providing plug-in capability to any number of applications without extensive re-programming, and may thereby enable parties outside of the described system to create components that plug into the architecture as well as allowing the instant system to plug into third party architectures.

The architecture of the present invention may provide, for example, applications accessible to one or more users to perform one or more functions. Such applications may be available at the same location as the user, or at a location remote from the user. Each application may provide a graphical user interface (GUI) for ease of interaction by the user with information resident in the system. The GUI may be specific to a user, a set or type of users, or may be the same for all users or a selected subset of users. The uniqueness of the GUI may be indicated by the user, or optionally offered as selections within the GUI by the architecture. The architecture may also provide a master GUI that allows a user to select or interact with GUIs of one or more other applications, or that allows a user to simultaneously access a variety of information otherwise available through any portion of the present invention.

Presentation of data through the architecture may be in any sort and number of selectable formats. For example, a multi-layer format may be used, wherein additional information is available by viewing successively lower layers of presented information. Such layers may be made available by the use of drop down menus, tabbed pseudo-manila folder files, or other layering techniques understood by those skilled in the art. Formats may also include AutoFill functionality, wherein data may be filled responsively to the entry of partial data in a particular field by the user. All formats may be in standard and/or normalized readable formats, such as XML.

The architecture may limit, for example, data manipulation, or information access. The architecture may also implement access or use restrictions for users at any level. Such restrictions may include, for example, the assignment of user names and passwords that allow the use of the present invention, or the selection of one or more data types that the subservient user is allowed to view or manipulate.

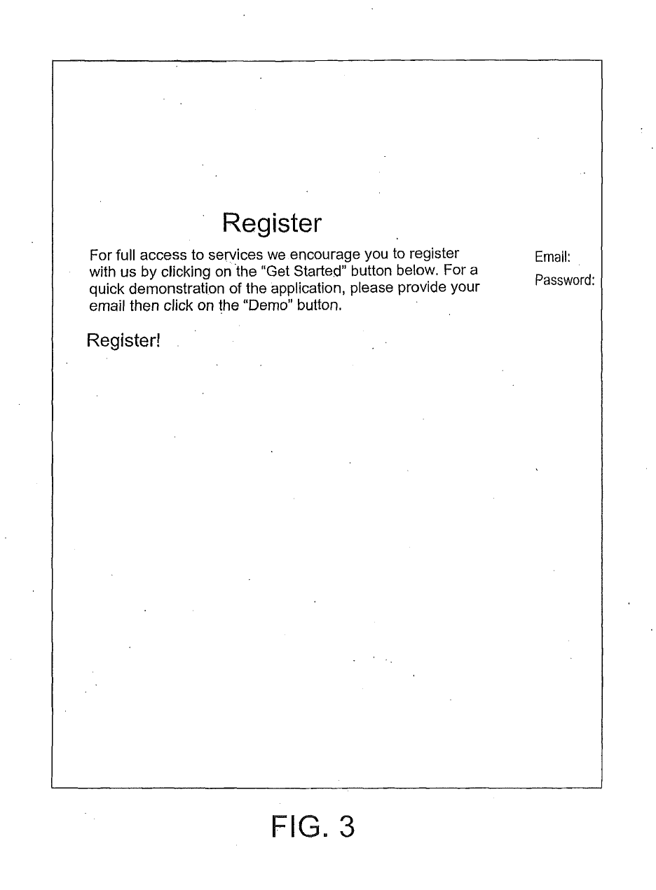

As shown in FIG. 3, individual user accounts may be established to customize information or to target information or promotional material to particular users or sets of users. Individual email accounts may also be established, or previously existing email accounts may be associated with individual user accounts.

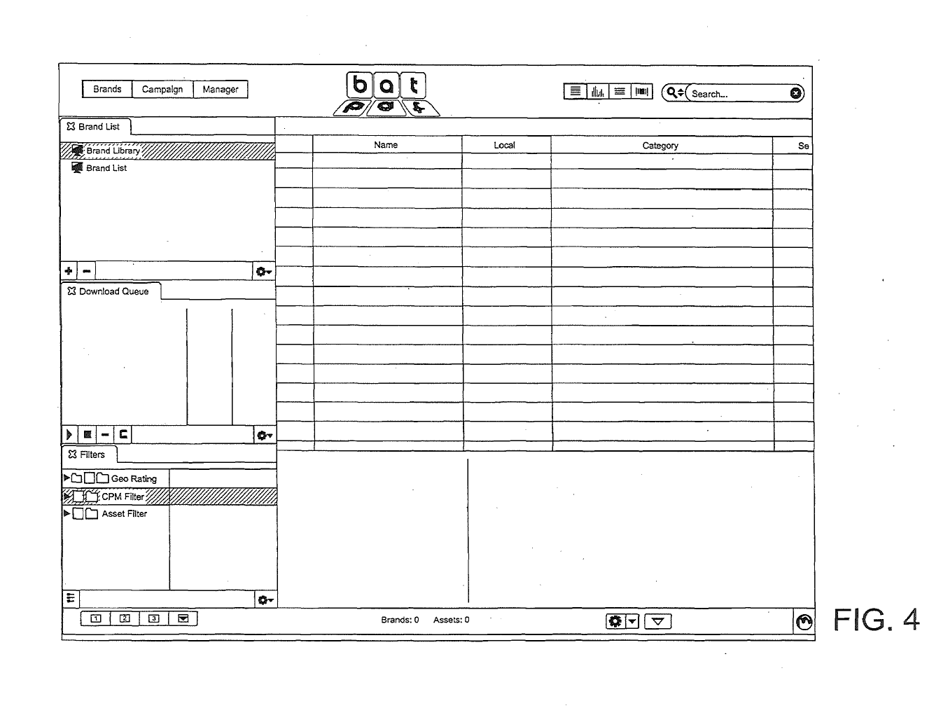

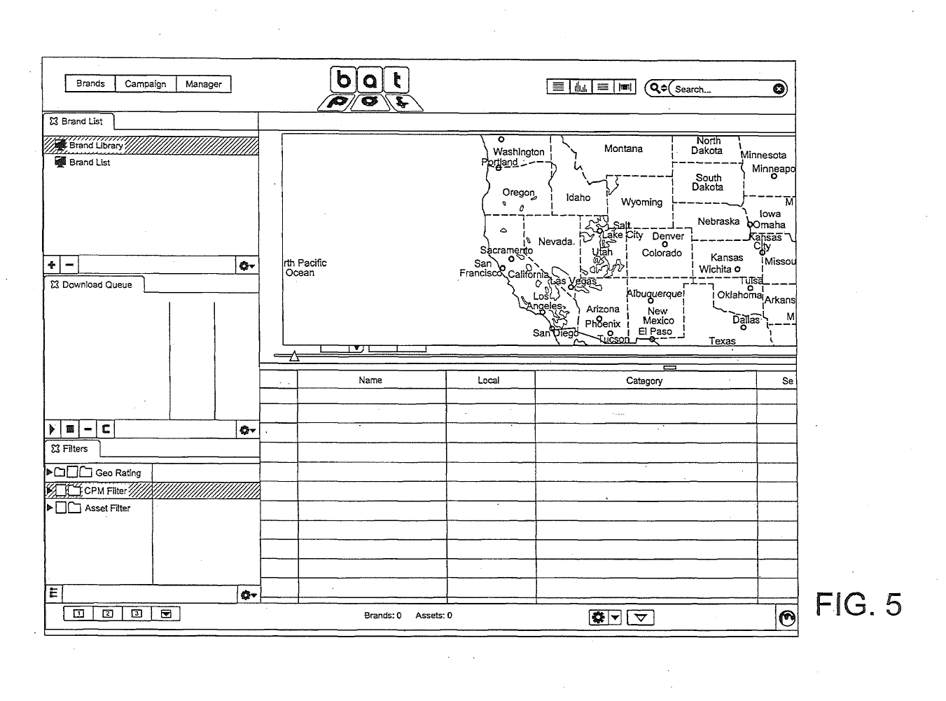

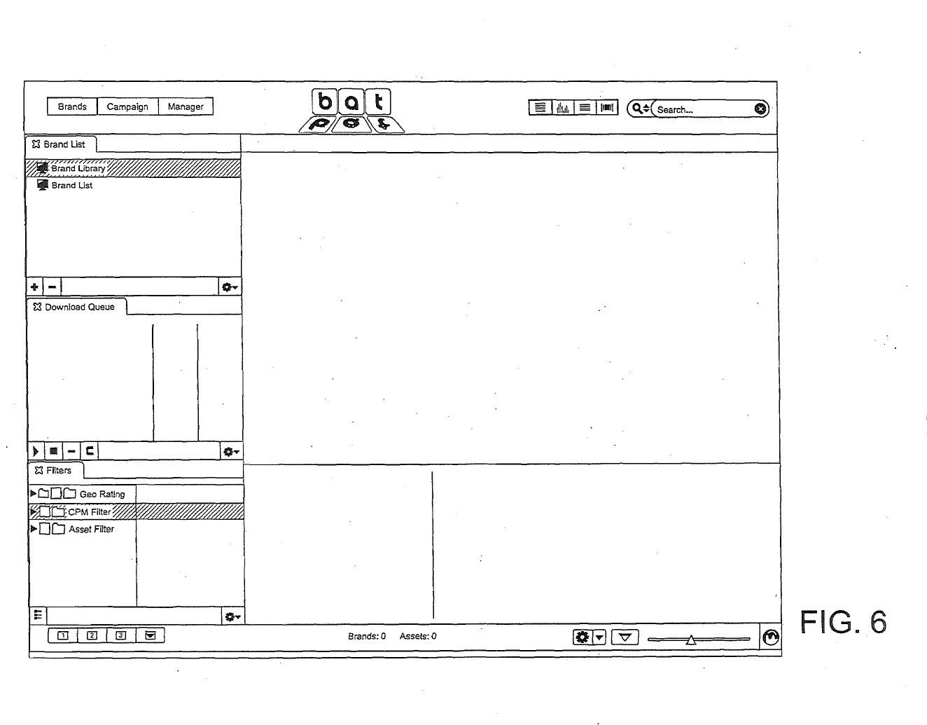

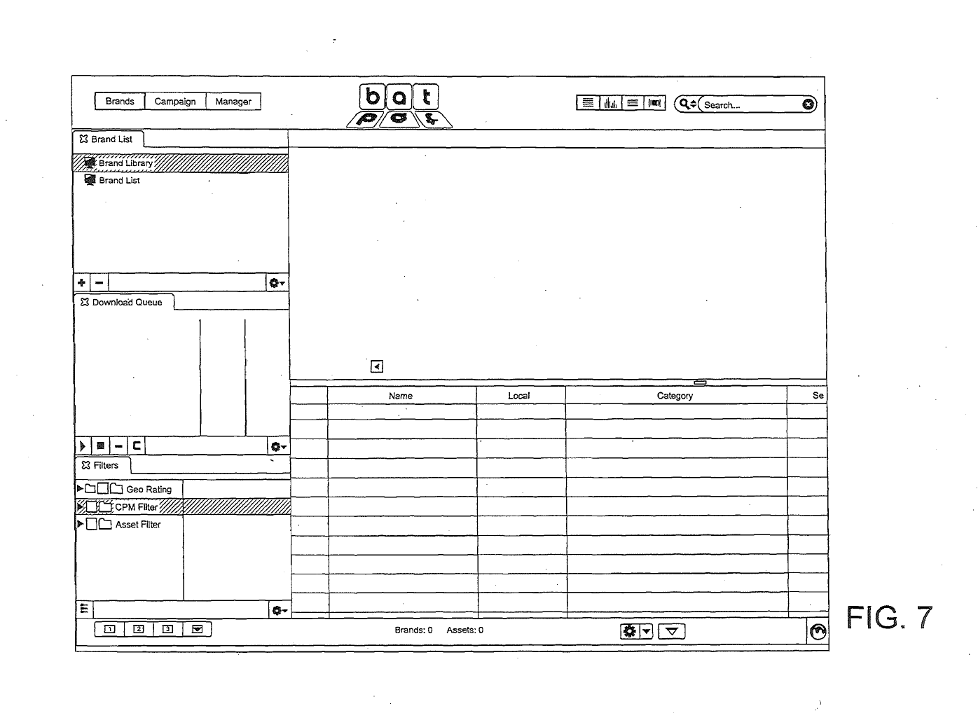

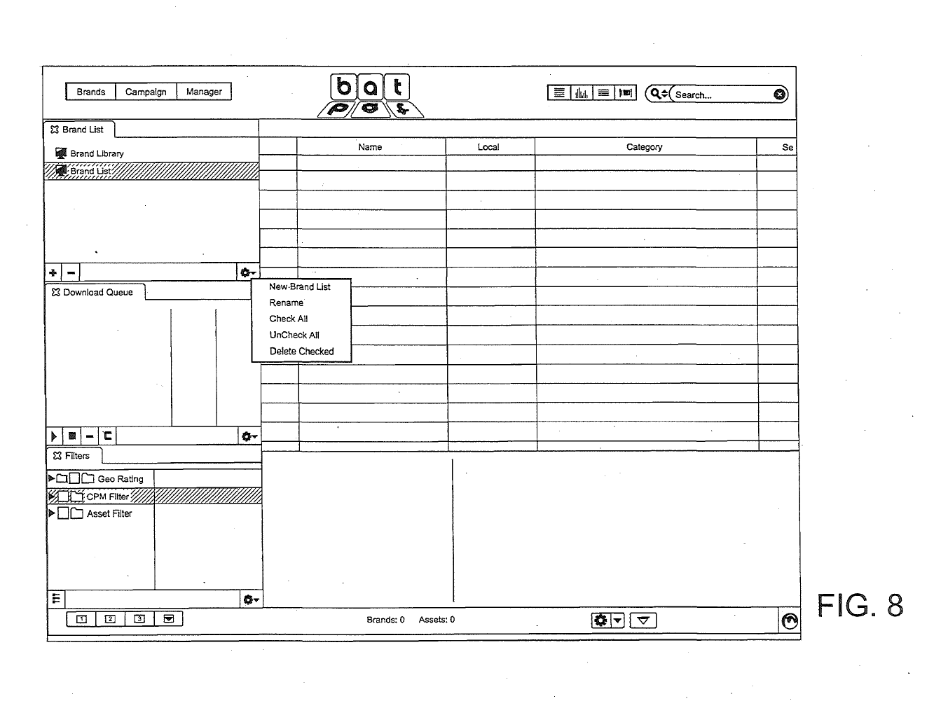

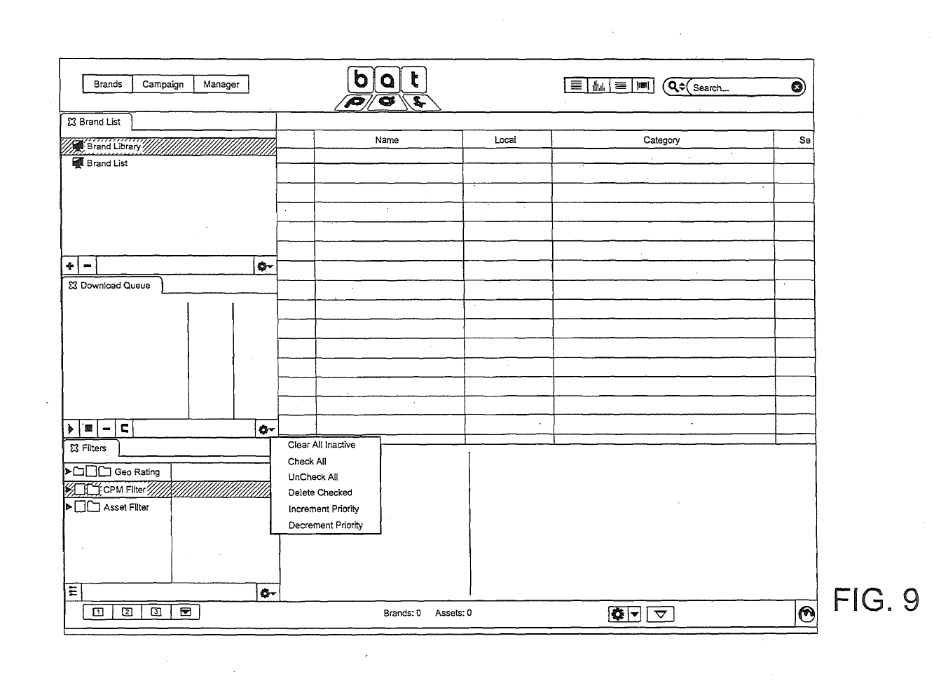

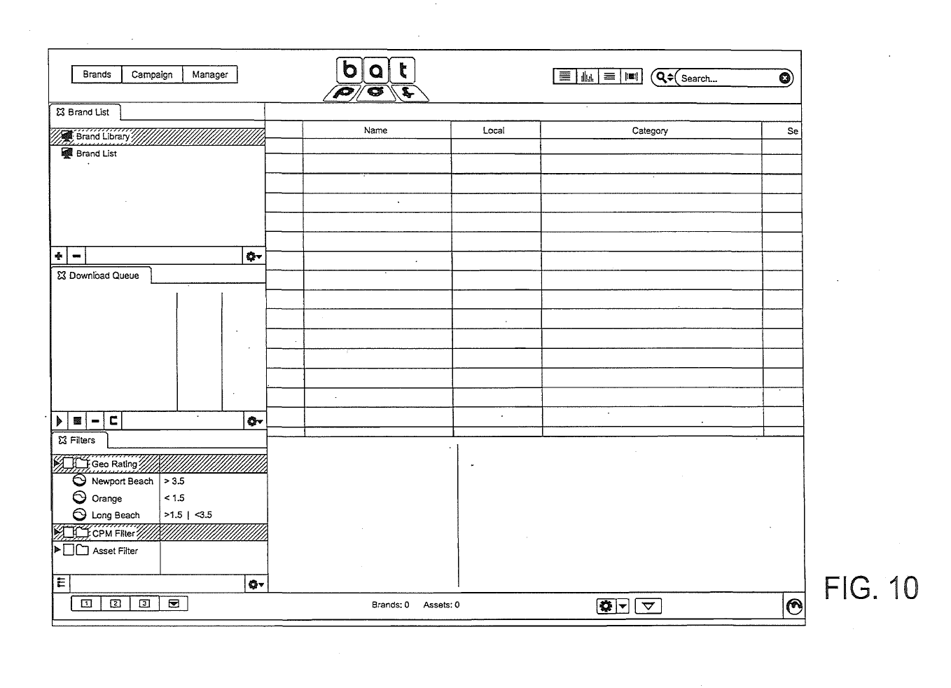

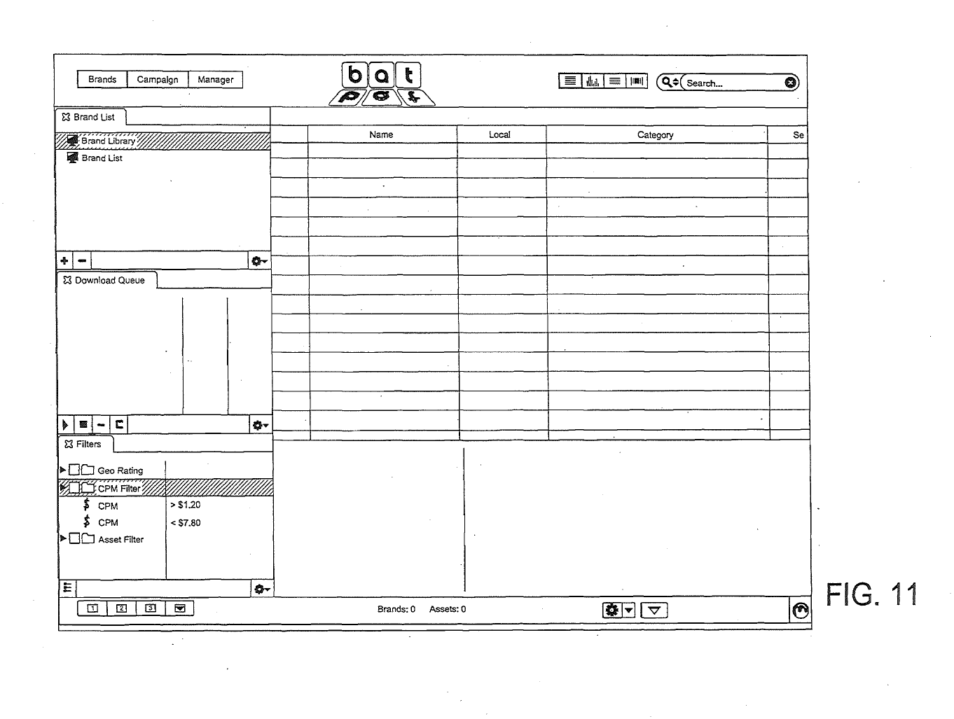

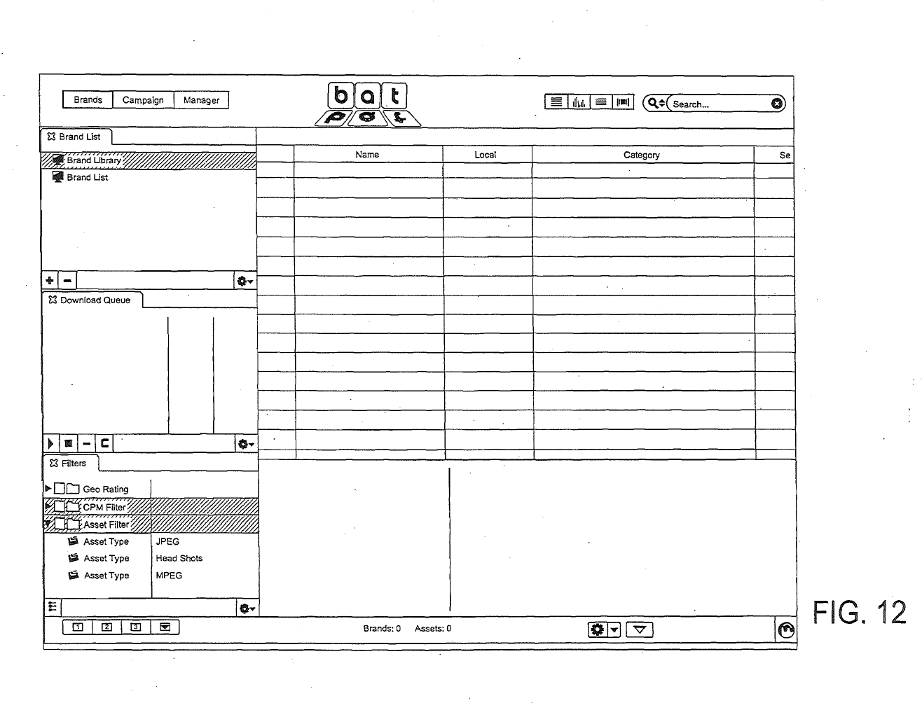

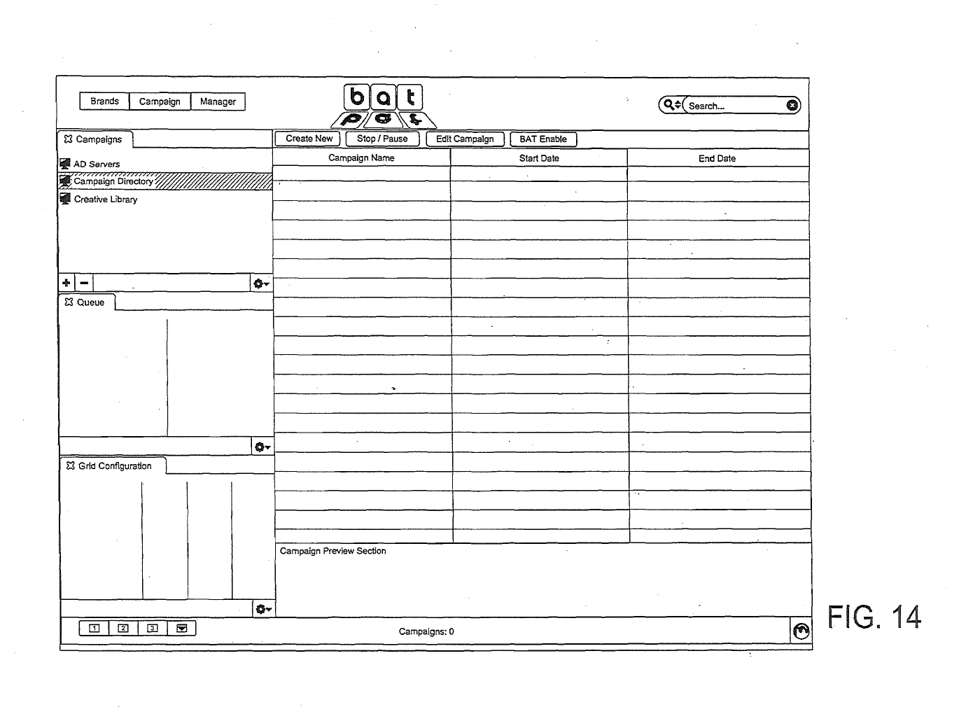

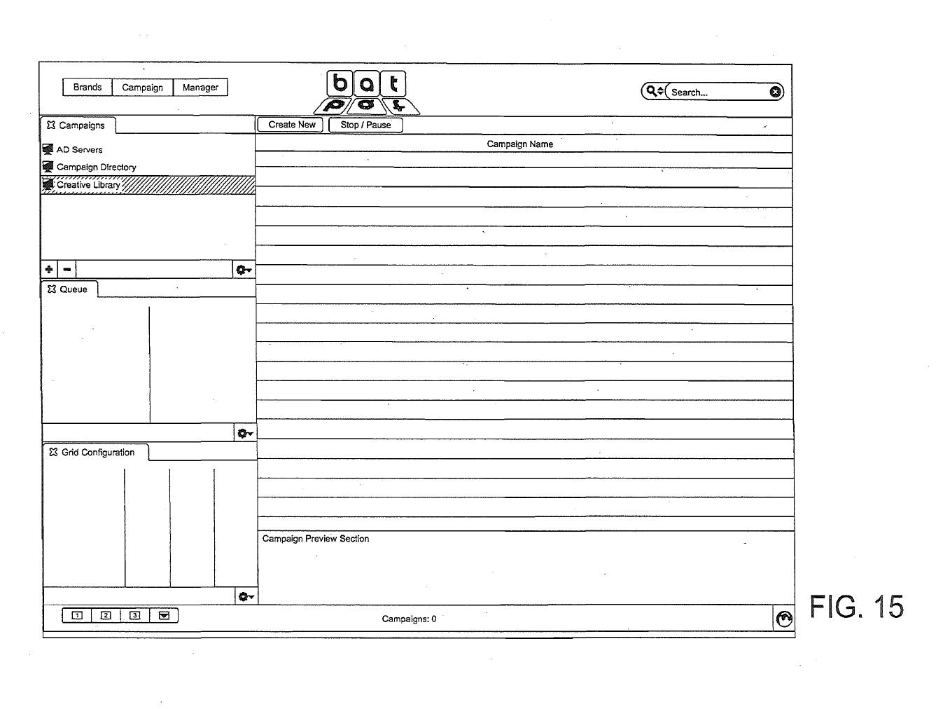

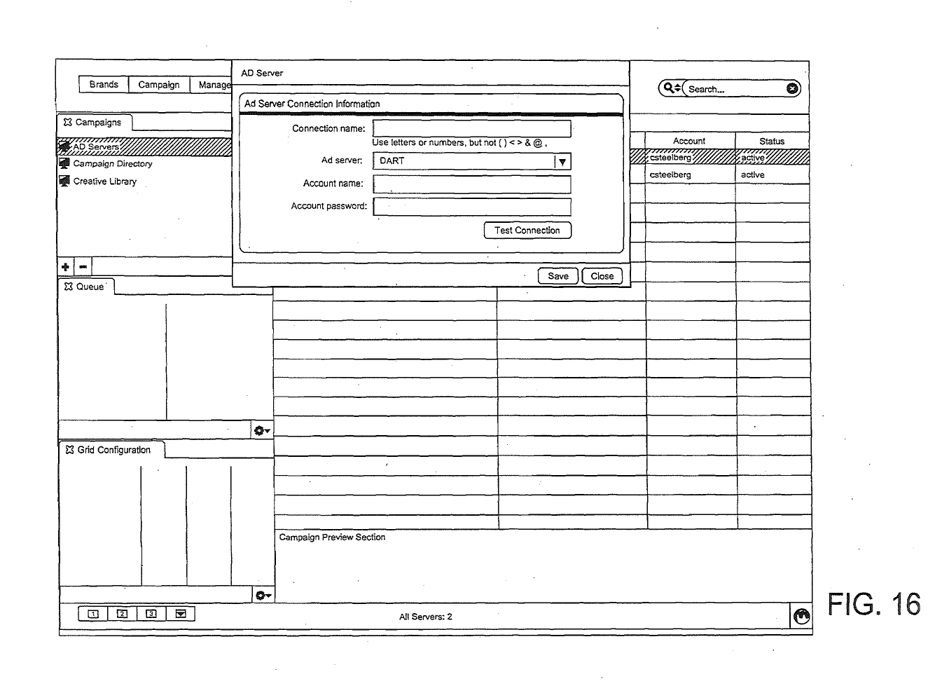

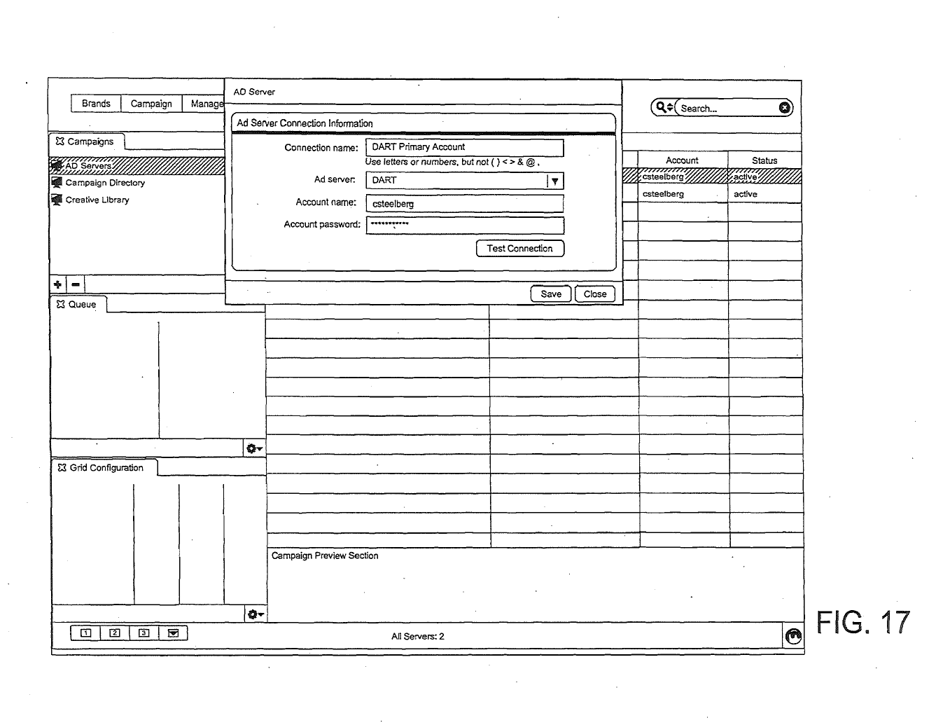

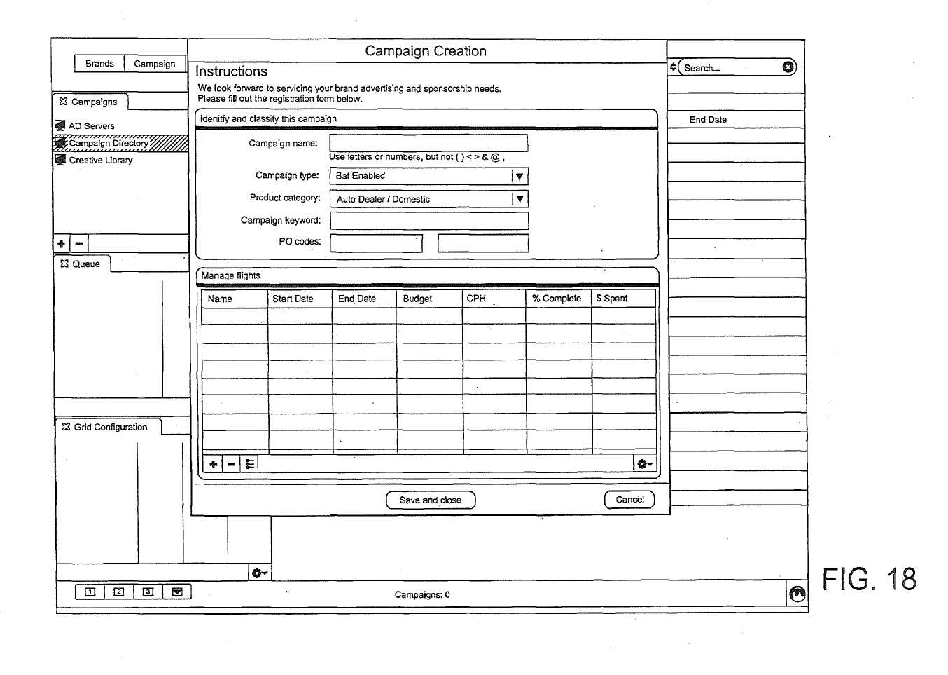

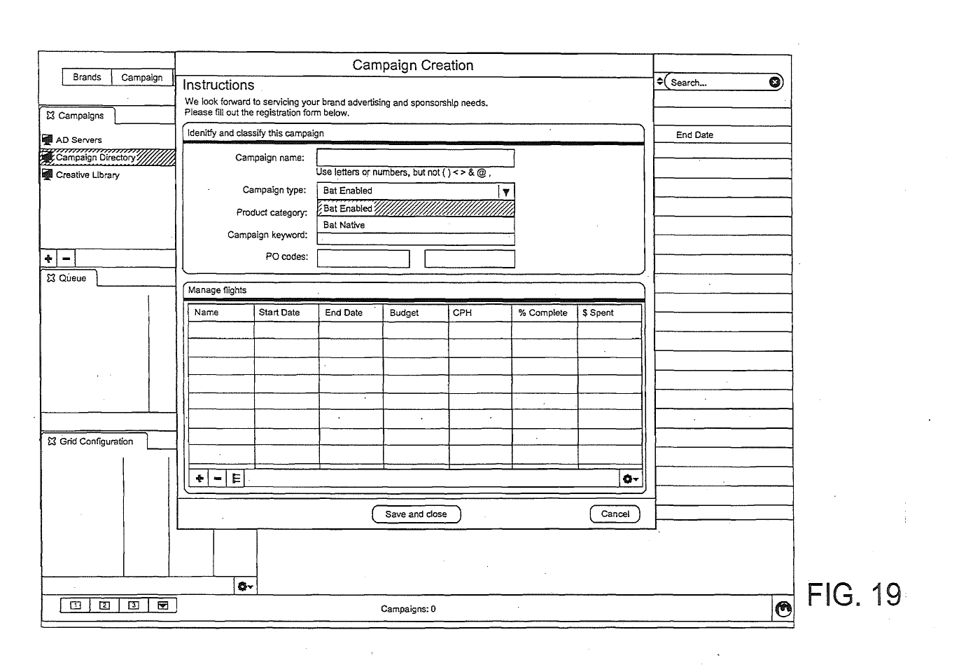

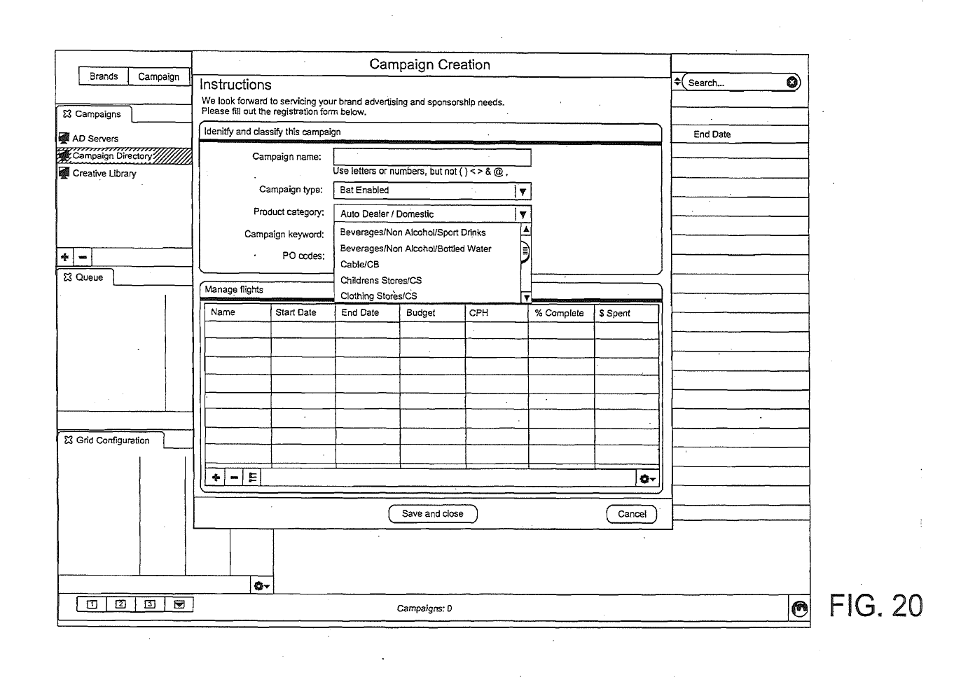

In other embodiments, as shown generally in FIGS. 4-21, a multi-layer format having selectable buttons or tabs is used, with selected layers occupying defined space on the graphical interface. For example, as shown in FIGS. 4-12, a user may select and develop a brand or branding schema. Brands, and those media assets associated with the brands, may be viewed in a listing or library format, selected for download, and may further be viewed or associated with a geographic or regional mapping program. Media assets associated with the brands may also be viewed as picture or video files and visualized with any sort of media player application as understood by those having skill in the art. A filtering system may also be used. For example, assets may be filtered by an asset class, such as file type, file size or visual aspect of the asset, such as a head shot. Filters may also be based on cost, such as a cost per minute. Costs may further be filtered on cost ranges, or threshold values to which costs must be above or below. Filters may further be constructed based on geographic ratings. For example, a rating system, such as one based on population and/or distance metrics, can be used to rank and filter brands and media assets based on threshold ranking values or value ranges.

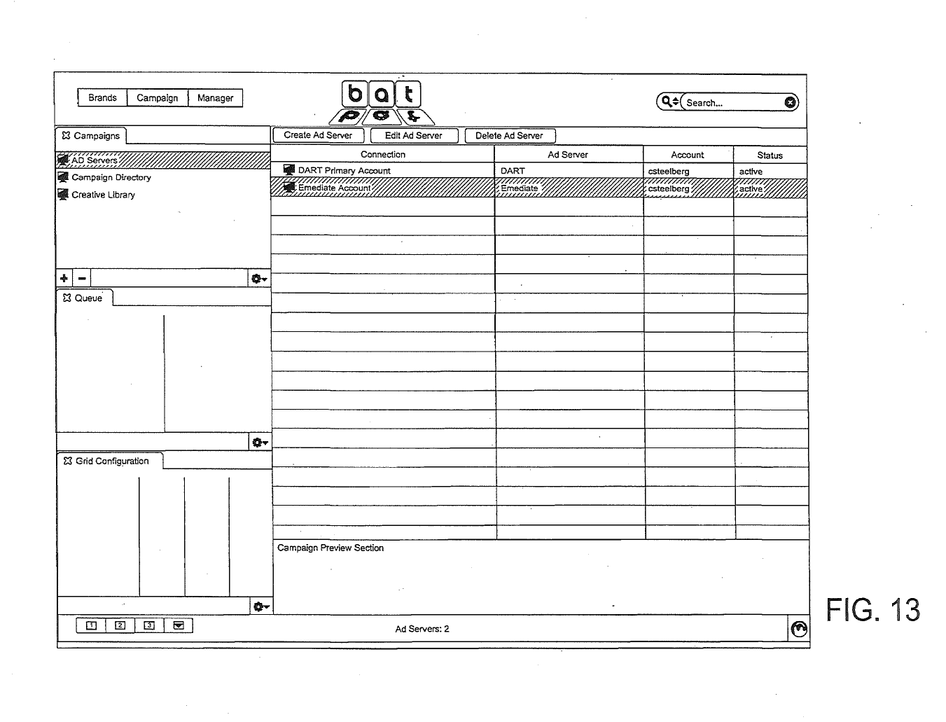

In another example, as shown in FIGS. 13-20, a user may select and develop advertising campaigns. For example, accounts with various ad servers, through which the advertising campaigns may be run, may be created, edited or deleted from a server list. When creating an ad server, account information may be established, such as account names, passwords and connection information to provide identifiers and connectivity with the ad servers. Campaign directories and libraries may also be created. Such directories and libraries identify and categorize those campaigns already created. New campaigns may of course be created. In the creation of a new campaign, information relating to the campaign name, type, product category, and any associated codes and keywords may be entered and established for the new campaign.

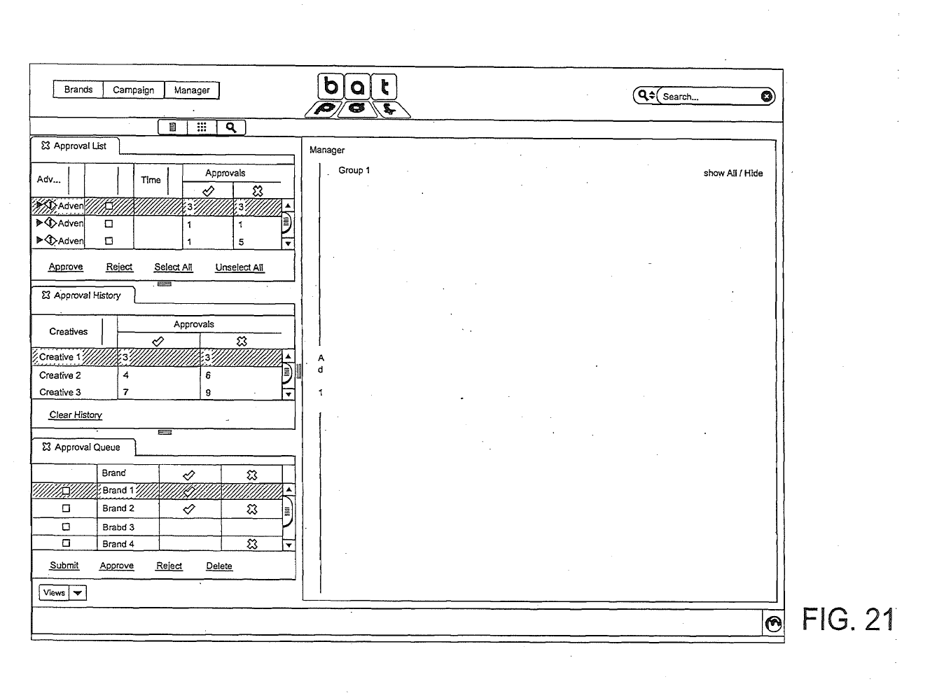

Manager functionality, as shown in FIG. 21, may provide a manager the ability to perform managerial and administrative tasks associated with selected and/or developed campaigns, brands, creatives and media assets. For example, managerial access may be provided to the user, and selected items may be presented in an approval list. The approval list may be organized such that the user may efficiently identify what has been approved or rejected, and at what time such approval or rejection was made. Further, data sorting may provide for identification of those items still requiring approval. Data relating to the approval process may be compiled to provide statistical data, as understood by those having skill in the art. In another example, an approval history may associated with a creatives list, or other items such as brands, assets or campaigns. An approval queue may also be implemented for storing and sorting those items for future approval.

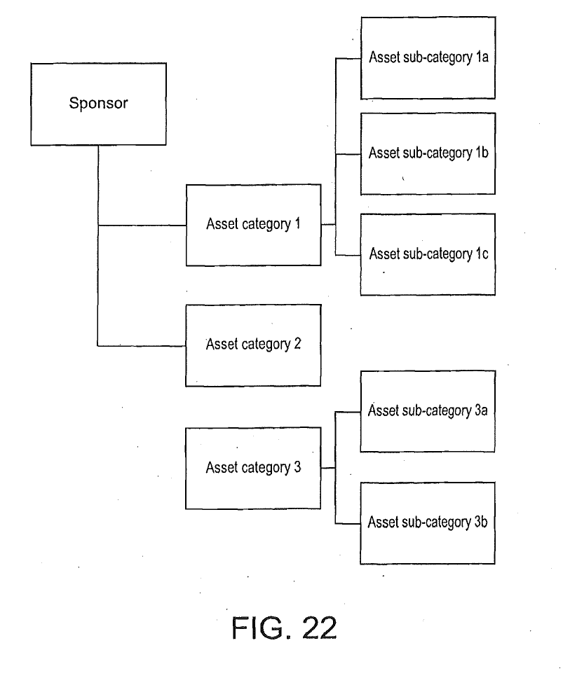

According to another aspect of the present invention, various sponsors, meaning specific individuals, entities, affinity brands, or marketing partners, for example, may be presented to a user via the system or interface in a manner that provides for ease of viewing and selection of assets associated with a particular sponsor. For example, as shown in FIG. 22, a tree menu may be used to organize those assets associated with the particular sponsor. Starting with the sponsor, any number of general asset categories can be established. These categories can be based on any sort or type of factors, such as geography, timeframe, activity, product, or any other factor relevant to the assets. Likewise, these general asset categories may each have any number of sub-categories, thereby creating a multi-level or multi-tier tree, where each level or tier provides a more narrowed set of assets to select from. In another exemplary embodiment, hierarchical pull-down menus may be used to establish categorical levels of assets associated with a particular sponsor. These pull-down menus may ultimately provide the same functionality as the tree menu, albeit in a different programmable and visual format. In yet another embodiment, sponsors may be presented as a virtual rolodex or series of selectable cards. In this embodiment, a user may scroll through the available sponsors via a scroll bar, or by dragging portions of the sponsor card, such that the user may “flip” or “turn” each card or particular cards successively. Upon identifying the desired sponsor, the user may select the sponsor and be provided a list of assets associate with that sponsor. The organization of those assets may be any of the methods described herein, as well as those other methods as understood by those having skill in the art.

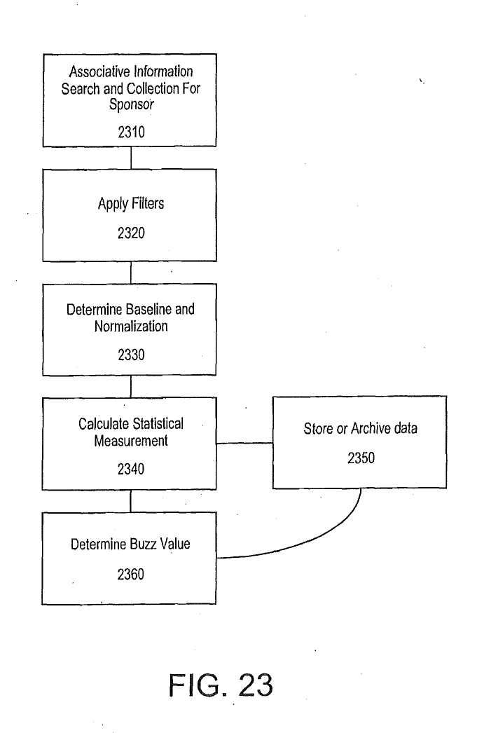

According to another aspect of the present invention, a variety of associative information may be attributable to and complement any particular sponsor, such that when a user selects a sponsor to generate a creative, ad or campaign, the associative information attributable to that sponsor will be available to aid the user in the selection and distribution of the various assets also associated with that sponsor. For example, current, real-time news or events involving a sponsor would be made available to a user upon selection of the sponsor. As shown in the FIG. 23, a method of generating buzz values attributable to a given sponsor is provided. In step 2310, associative information for a sponsor is searched for and collected. In step 2320, any number of filters may be applied, such as geographic parameters, time-sensitive metrics, and product based, for example. In step 2330, a baseline value and normalization techniques are applied. In step 2340, statistical mechanisms are determined and applied to the collected data. In step 2350, the collected data may be stored. In step 2360, the final buzz value is determined.

Associative information can be collected for all sponsors continuously, and stored for a predetermined time, such as a week, month or year. Alternatively, associative information can be searched for and presented to the user upon selection of the sponsor. Presentation of any associative information may be made by drill down techniques, pop-up windows, menu selections, or any other mechanism as described herein or otherwise understood by those having skill in the art.

Associative information may be categorized and organized in a similar manner as for assets as described herein. Associative information may further be processed into statistical data, such that graphs, charts, comparators and rating scales and/or systems may be generated to provide a user with data determinative of the real-time popularity or value fluctuations over time, geography, or any other parameter, for a given asset. The accumulation of the monitoring, collection and analysis of associative information may effectively create a “buzz” value, that positively or negatively temporarily effects the value of certain assets associated with a particular asset.

In a process of evaluating associative information, values can be attributed and normalized to reduce the effects unrelated to the buzz around an asset. For example, while values are likely to grow from midnight to midday in a given geographical area surrounding the locale of a sponsor, and where media users are awake and add to the associative information, the value measurements can be normalized to remove time of day variations. Other variations, such as seasonal variations, weekly variations and general topic variations (when examining buzz for more specific topics), can also be normalized out. Ratios and difference measurements might also be performed in comparing two or more topics, terms or categories to determine relative buzz.

When the “buzz”, or statistical measure of interest, is determined for a sponsor, that information can be used in many ways. For example, users might be interested in seeing the current popularity of a less-expensive sponsor, or determine the current quality of a more-expensive sponsor, in that the more-expensive sponsor may have a buzz in a particular region that negatively effects the value of that sponsor. Naturally, users may wish to dynamically switch their advertising campaigns to follow sponsors having increased or elevated buzz. Alternatively, a buzz value can change the value of the sponsors prior to selection, such that prices associated with particular sponsors may fluctuate in real-time.

According to another aspect of the present invention, the system may pull a user's ad campaigns from existing ad servers to provide a single location for ad campaign development and organization. Once these existing ad campaigns are brought into the system, they can be broken down, added to or integrated with those ad campaign tools provided by the present invention. For example, a user can tailor the ad templates based on existing campaigns to generate new campaigns with a particular sponsor. This methodology may allow a user to manage and track all such features from a single source or engine. It may further allow the user, via the engine as described herein, to control the trafficking of ads according to a unified set of business rules, provide coordinated ad targeting to different users or content, and centralize all tuning and optimization based on generated creatives or campaigns, or results. Further, all data related to reporting impressions, clicks, post-click and post-impression activities, and any interaction metrics can be collected and processed from the single location. It may also provide a automated and/or semi-automated means of optimizing bid prices, placement, targeting, or other characteristics of the ad, campaign or asset set. For example, use of a profile of prior behavior on the part of the viewer may determine which ad to develop and show. Contextual information may be developed as contained from locations where the ad will be served. Generally speaking, experimental or predictive methods may be used to explore the optimum creative for a given ad placement and for exploiting any such determination in further impressions, as will be understood by those skilled in the art.

In accordance with an embodiment of the present invention, the use of discounting and/or variable discounting may be used in connection with the endorser and a particular product, service, or business. In general terms, an endorser, such as a celebrity, may endorse, through at least one advertisement, certain services and/or goods. Such an endorsement may include a discount based on the consumer acting on an endorsement to purchase the goods and/or services. The consumer may be incentivized to act on an endorsement by the offering of a discount in connection with the endorsement. Such a discount may be temporal in time, may vary over a specific time period, and/or may be related to the number of consumers acting on the endorsement, for example.

For example, a celebrity may endorse the use of a local oil change company. The advertisement may, for example, contain information related to a discount that may, for example, include an 80% off services for the first 12 hours after the endorsement by the celebrity. The discount of 80% for the first 12 hours may decrease every hour after the first 12 such that there is a decrease in the discount of 10% every hour thereafter.

The terms of a discount based on an endorsement may further be influenced by the actual consumption of consumers acting on an endorsement. For example, a discount of 30% set by the endorsement may increase by a factor of 10 if, for example, 30 consumers consummate 30 unique transactions based on the endorsement. Of course, the consummated transactions may occur during a finite or defined period of time relative to the endorsement. For example, the elevation of the discount based on consumers' activity may be calculated every hour, every 2 hours, every day, or calculated when certain consumer thresholds are met, such as once every 30 transactions are consummated.

In an embodiment of the present invention, an initial discount offered through an advertisement may decrease as a function of time and/or increase as a function of consumer consumption as illustrated in the following formula:

% Discount=Initial Discount/time*Consumption/Gross Transaction Rate

The percent discount that may be offered for a particular good or service may be equal to the initial discount or bounty offered through the endorsed advertisement divided by the time defined within the advertisement multiplied by the result of the number of unique transactions consummated divided by a gross transaction rate. As previously described, the number of unique transactions and the gross transaction rate may be calculated either over a predefined period of time and/or in conjunction with a predefined number of unique transactions. As will be apparent to those skilled in the art., the formula above is prophetic and, as described herein, provides a basis for the variation in the discount offered using a variety of factors.

For example, an endorsement advertisement may offer an 80% discount on car tires purchased within 12 hours of the endorsed advertisement. After the first 12 hour period, the percent discount may be dropped to 40% for the following 12 hour period, and to 20% for the next 12 hour period, and finally ending after a final 12 hour period, for example.

However, the calculated discount may rise if there are a high number of unique transactions completed during the pendency of the discount. For example, if during the second 12-hour period when the discount has dropped to 40%, there are 30 unique transactions for the purchase of the endorsed good, and these 30 transactions exceed the number of unique transactions predefined by the seller of the good, then the discounted rate may, for example, remain at 40% for the following 12-hour period. Similarly, if during the same 12-hour period 60 individual transactions are consummated, and 60 unique transactions are a threshold for an increase in the discount, then the following 12-hour period may have the discount increased to, for example, 60%.

In an embodiment of the present invention, the traffic to and transactions consummated on a particular e-commerce site may be tracked for use with the variation in discount and for the compensation of an endorser. Such tracking may be controlled by the use of a URL provided through the endorsed advertisement and/or by advanced agreement and approval with the system of he present invention. Of course, as would be appreciated by those skilled in the art, the thresholds for unique transactions during the time period and the variations in the change in percent discount during various time periods based on the number of unique transactions may be innumerable and not limited to transactions directly consequential to the endorsement and/or advertisement.

The variations in the discount offered as a function of time and amounts of actual consumption of the product or service may or may not be understood or known to the consumer targeted by the endorsed advertisement. Such terms, as described more fully herein, may be explicitly included within the endorsed advertisement, partially included within the endorsed advertisement, partially included at the point of sale, and/or provided through a defined location, such as a website, for example.

As used herein, with regards to a social network, an endorser in the form of a celebrity may be any person or persons with a social network following of at least 50,000 people, for example. Outside a definable electronic following, a celebrity may a person who is known for at least one particular reason by a high number of people. For example, a person known by 20% of adults in the United States may have “national” celebrity, while the quarterback for a local high school team, known by at least a majority of those attending the high school might be a “local” celebrity.

An endorsed advertisement used within the system may emanate in traditional television and/or radio media, or be disseminated through social networks and/or other like media. For example, a celebrity may put forth an endorsement and/or advertisement into a social network stream such as Twitter® and/or Facebook® for which the celebrity has a following. Thus, a celebrity may, for example, tweet an endorsement for a particular good or service and may indicate the terms of the discount. The endorser may also rely on the use of a trademark or other designation which may inform the targeted consumer of the terms and conditions related to the discount offer.

For example, the use of a trademark and/or URL link within a posted endorsed advertisement may identify to the targeted consumer the source of the terms and conditions of the discount. As would be appreciated by those skilled in the art, a clearinghouse website may be used to provide the terms and conditions related to discounts offered by endorsers through the present invention. Such a website may be independently advertised such as to further enhance the consumer's knowledge and confidence in the discounting offer put forth by a given celebrity.

By way of example, a celebrity endorsing a product or service at 10 am on a Saturday morning may post an endorsement for a sneaker company, and add to the posted endorsement an icon signifying the percent of the initial discount. The icon presented may inform the targeted consumer of the source of the terms and conditions regarding the endorsement, along with the initial discount being offered, for example. Thus, the consumer will understand that starting at 10 am on Saturday morning for the next at least 12 hours, the endorsed shoe company will be offering an 80% discount within their store and, for example, a 40% discount for the following 3 hours. The consumer may also recognize, by association with the mark used by the endorser, that the discount may be varied depending on the number of people who may actually purchase shoes from the shoe company within a defined period of time. Of course, as described above, the terms and conditions may also be explicitly provided within an endorsed advertisement.

In an embodiment of the present invention, at least one celebrity which may endorse at least one product may be provided compensation for their endorsement. Such compensation may be based on the number of actual transactions that take place as a result of the endorsement, or may be based on the total receipts taken in again as a function of the endorsement. For example, the endorser may be paid an amount of money per individual transaction, such as a set or predetermined fee, or may be provided a percentage of the total gross receipts generated by the endorsement, for example. In addition to the approval and review functionality included within the present invention as described above, the endorser may further choose to have the remuneration due them through such endorsements alternatively provided to an organization of their choice and/or charity, for example. Such a choice may be information included with the endorsement.

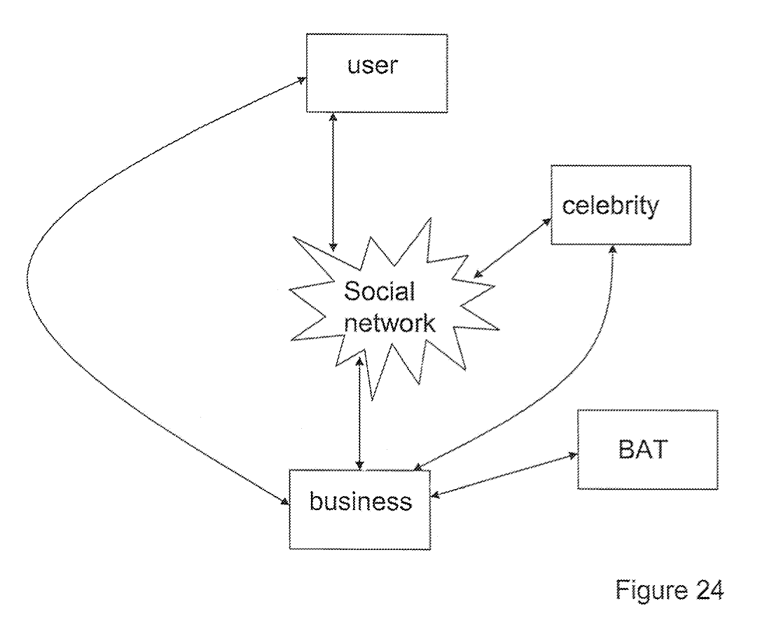

As illustrated in FIG. 24, the present invention may facilitate and incentivize the endorsed advertisement of a good or service by a celebrity. In accordance with the present invention, a celebrity may have approved a particular creative and may further approve of the creatives insertion into at least one existing social network associated with the celebrity.

In an embodiment of the present invention, a celebrity may have at least one but no more than three active endorsements at any given time period. Such a limitation on offers may be limited to specific geographies, product lines, and/or media type, for example. Similarly, the system may also limit and/or control advertisements that may overlap on the basis of product being endorsed, the nature of the celebrity (for example, celebrities from a specific sports team and/or genre, such as film or stage), and/or by market. In this way, the specific may prevent overlap between fans associated with similar celebrities in an effort to prevent dilution of the effect of the discounted offer.

For example, a discounted offer on car washes by an NFL player within the DMA associated with his or the NFL team, may be diluted by an offer or a discount on hamburgers by a team member during the same period of time relative to the car wash offer. Such a determination by the system may be based on the type of social network or media outlet used to reach the targeted consumer, and/or an analysis by the system of any overlap that may exist in the followers of the celebrity on, for example, a social network. Thus, for example, an overlap of greater than 30% of followers for a given celebrity in a given social media platform or platforms may be used to limit any overlapping or cross endorsements that may occur in the local targeted geographic area.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. An advertising engine for providing incentive-based offers, comprising:
providing at an advertising engine having at least one non-transitory computer readable storage medium having encoded thereon computer executable instructions at least one endorser for endorsing at least one advertisement;
receiving at least one item offered for a discounted sale price in conjunction with the at least one advertisement;
providing at least one tracking engine for tracking at least one attribute associated with the at least one item; and
adjusting the discounted sale price based on the at least one attribute.

2. The method of claim 1, wherein the at least one attribute is the number of units sold in a given period of time.

3. The method of claim 1, wherein the at least one attribute is a place, time of day, or calendar date.

4. The method of claim 1, wherein the at least one attribute is based on mentions of the at least one item in at least one social network.

5. The method of claim 1, wherein the endorser endorses at least two items.

6. The method of claim 1, wherein the at least one item is limited to a specific geographical area.

7. An advertising engine for providing incentive-based offers, comprising:
providing at an advertising engine having at least one non-transitory computer readable storage medium having encoded thereon computer executable instructions at least a first endorser and a second endorser for endorsing at least one advertisement;
receiving at least one item offered for a discounted sale price in conjunction with the at least one advertisement;
providing at least one tracking engine for tracking at least one attribute associated with the at least one item and at least one attribute associated with the first endorser and second endorser; and
restricting the endorsing of the at least one item by the first endorser based the at least one attribute associated with the at least one item and at least one attribute associated with the second endorser.

8. The method of claim 8, further comprising the adjusting of the discounted sale price based on the at least one attribute associated with the at least one item.

9. The method of claim 8, further comprising the adjusting of the discounted sale price based on the at least one attribute associated with the first endorser.

10. The method of claim 8, further comprising the adjusting of the discounted sale price based on the at least one attribute associated with the second endorser.

11. The method of claim 1, wherein the at least one attribute associated with the at least one item is the number of units sold in a given period of time.

12. The method of claim 1, wherein the at least one attribute associated with the at least one item is a place, time of day, or calendar date.

13. The method of claim 1, wherein the at least one attribute associated with the at least one item is based on mentions of the at least one item in at least one social network.
